(19) United States
(12) Patent Application Publication
(10) Pub. No.: US 2019/0128057 A1
(43) Pub. Date: May 2, 2019

(54) Vehicle Curtain Apparatus

(71) Applicant: Richelle Futch, University Place, WA (US)

(72) Inventor: Richelle Futch, University Place, WA (US)

(21) Appl. No.: 15/796,750

(22) Filed: Oct. 28, 2017

(51) Int. Cl. E06B 9/24

(52) U.S. Cl. CPC E06B 9/24

(57) ABSTRACT

This disclosure relates generally to a portable dressing room of tent-like form which is attachable to a vehicle, such as an automobile, and adapted for use for making clothing changes. This invention would attach to the hatchback door that swings upward of the vehicle, or on two doors of the same side of the vehicle by magnets for metal vehicles or hooks applied to not metal doors with a type of adhesive so the invention can hang onto the hooks though loops.

### BACKGROUND

### Field of the Invention

The present invention to a new changing curtain device for attaching to a vehicle so that a person may change their clothes in privacy as needed in public.

### Description of the Related Art

Easy automobile access to parks, beaches, bike trails, hiking trails, and other kinds of outdoor recreational areas have given people more opportunities than ever to enjoy the outdoors. Unfortunately, the more people visit these areas, more crowded and stressed they become. Among other problems this overcrowding can cause is a shortage of privacy spaces available for changing into and out of clothes, uniforms, swimsuits, and/or other gear at the recreational area.

For example, outdoor enthusiasts such as surfers, swimmers, bikers, hikers; and sports participants now frequently face inconvenient and/or ineffectual choices for changing in private. These include driving to a less populated and/or less public place to change. Unfortunately, driving in a wet bathing suit or exceedingly dirty clothes can be as or more inconvenient than exposing oneself in public.

Some try looking for less populated parts of the recreation area and/or indigenous cover such as trees, bushes, and buildings in hopes of changing with some amount of privacy. Unfortunately, as more people flock to these areas, especially on nice days and/or at the height of the tourist season, finding such a secluded location can be exceeding difficult if not impossible. Still others try to use on-site public restroom to change clothes. Unfortunately, crowded recreation areas typically have limited restroom facilities that have to accommodate people relieving themselves as well as changers. This often results in long waits to use the facilities and many frustrated patrons. In many areas, such as trailheads for hikers and bikers, there are no restroom facilities at all.

Another option for those desiring to change in private is to bring the privacy space with them to the recreation area. This includes changing in the automobile itself, pitching a tent in which to change, or wrapping oneself in a large towel while trying to change clothes underneath. Unfortunately, each of these options includes a host of difficulties and inconveniences. Many automobiles, such as compact and subcompact cars, have small interiors that require difficult contortions during the changing process. In addition, the windows on the front, back and sides of the vehicle need to be screened to insure complete privacy. A tent that is large enough for changing can be exceedingly cumbersome to pack and transport in a vehicle. Moreover, pitching and tearing down the tent can be very time consuming relative to the time needed to change clothes. Wrapping oneself in a towel and attempting to change underneath can be a challenge for even the most dexterous clothes changer. Oftentimes the towel comes undone during all the shifting and twisting resulting in a potentially catastrophic wardrobe malfunction.

There have also been attempts to use a car as a support for an attached, adjacent privacy structure. Unfortunately, these structures typically include a complex scaffolding that can be difficult assemble and disassemble, as well as being difficult to attach to the car. Thus, like pitching a tent, the creation of the privacy space can be much more time consuming than the time needed to change clothes. Thus, there remains a need for portable privacy spaces that are easily formed and stored to allow people to quickly and conveniently change clothes in an outdoor area.

The use of changing curtain devices is known in the prior art. U.S. Pat. No. 2,204,432 describes a tent assembly that is attachable to a vehicle and which uses the vehicle for support. Another type of changing curtain device is U.S. Pat. No. 5,937,452 which includes a collapsible tent assembly used for providing a bathroom covering. Yet another such device is found in U.S. Pat. No. 4,457,853 which includes a portable shower assembly for attaching to a vehicle which can be slidably extended outwardly from a vehicle.

However, to Applicant's knowledge, none of these prior art methods have been found to be completely suitable to meet these needs and are cumbersome and non-durable. Hence, the inventor of the present invention proposes to resolve and surmount existent technical difficulties and to eliminate the aforementioned shortcomings of prior art. The overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment the invention would attach to the hatchback door that swings upward of the vehicle, or on two doors of the same side of the vehicle by magnets for metal vehicles or hooks applied to not metal doors with a type of adhesive so the invention can hang onto the hooks through loops. The invention is made of different materials that serve like a curtain for home windows or a shower curtain. The invention would cover the entire back of a hatchback vehicle from top to bottom and cover along the sides to offer full privacy. The length of the material would also cover the same degree of privacy if used on the side of the vehicle.

A primary object of this invention is to provide a collapsible privacy curtain, of flexible material or the like, which may be hung from the side or back of a vehicle temporarily.

A further object is to provide a privacy curtain including a supporting frame which may be secured in an automobile hatchback door or side doors of either side without interfering with the raising and lowering of the window.

An additional object is to provide a device which is of relatively simple and low cost construction, which is easily installed and removed and which is constructed from several readily separable parts whereby the device may be dis-assembled and stored in a compact form.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows the schematic view of the privacy curtain setup on hatchback door.

FIG. 200 shows another perspective view of the privacy curtain setup on hatchback door.

FIG. 300 is a view of privacy screen setup on side doors.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of construction and arrangement of parts illustrated in the drawings since the invention is capable of other embodiments and of being practiced or carried out in various ways. It is also to be understood that the phraseology or terminology employed is for the purpose of description only and not of limitation.

A privacy space is described that is portable and easily formed and deconstructed using a privacy sheet attached to a car, truck, or other vehicle. The privacy space provides a user with a confined but comfortable area to remove clothing and/or change clothing, among other activities. A significant portion of the privacy space is formed by the vehicle, reducing the amount of sheet material required to complete the space, and obviating the need for scaffolding or other stiff structural elements to support the material. This allows the non-vehicular portion of the privacy space to be made from a simple opaque sheet that can be easily folded or rolled into a small volume that is easy to store and transport in the vehicle.

Considering the advances the invention would attach to the hatchback door that swings upward of the vehicle, or on two doors of the same side of the vehicle by magnets for metal vehicles or hooks applied to not metal doors with a type of adhesive so the invention can hang onto the hooks through loops.

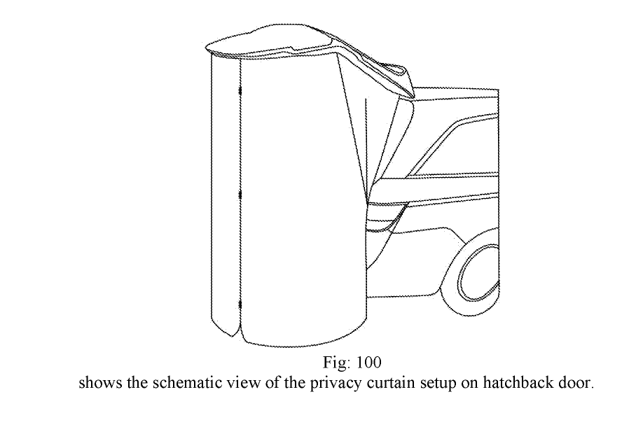

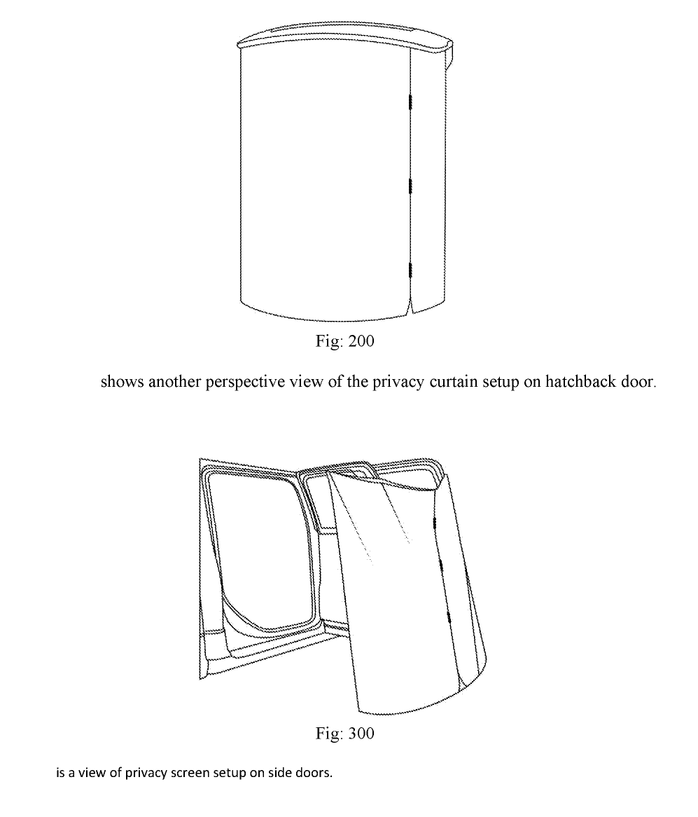

Referring now to FIG. 100 which shows plan view of the privacy curtain which can be unfolded easily to be used at back side of the hood by lifting up the back door. Similarly FIG. 200 shows another view of the privacy screen when mounted correctly on the hood. FIG. 300 shows the invention used on the either side of the car utilizing two doors.

The use of the invention is simple without any tedious effort. The user would hold curtain and connect magnets to the hatchback door all around the outside and let curtain hang down and step inside curtain for privacy. For use on the side of the vehicle user would attach magnet side of curtain to the outside edges of both doors while they are opened on the same side of the vehicle. For non-metal cars, user would apply hooks with adhesive for the inside of their vehicles that would remain in vehicle. Then when needing to use the invention, the user would attach the invention onto the hooks using the loops or holes on the curtain made for this use.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. The present invention is a privacy curtain comprising:
1) A detachable support assembly for a portable and collapsible privacy arrangement which may be attached on back hood door of the car when flipped up or on the either side of the doors of a conventional automobile or other similar support,
2) The assembly according to claim 1, comprises magnets in curtain. Using curtain for privacy in the two types of use as mentioned above on vehicles. Not for covering windows inside the vehicle. Attaching the curtain to adhesive hooks used attached to cars so that the curtain can be hung if non-metal vehicle.
3) The assembly according to claim 1, further comprises magnets for metal vehicles or hooks applied to not metal doors with a type of adhesive so the invention can hang onto the hooks though loops.
